(19) United States
(12) Patent Application Publication
(10) Pub. No.: US 2016/0097110 A1
(43) Pub. Date: Apr. 7, 2016

(54) METHOD FOR MANUFACTURING RARE-EARTH MAGNETS

(71) Applicant: TOYOTA JIDOSHA KABUSHIKI KAISHA, Toyota-shi (JP)

(72) Inventors: Daisuke ICHIGOZAKI, Toyota-shi (JP); Kensuke KOMORI, Toyota-shi (JP); Daisuke SAKUMA, Nagoya-shi (JP); Takaaki TAKAHASHI, Toyota-shi (JP)

(73) Assignee: TOYOTA JIDOSHA KABUSHIKI KAISHA, Toyota-shi (JP)

(21) Appl. No.: 14/859,579

(22) Filed: Sep. 21, 2015

(30) Foreign Application Priority Data
Oct. 7, 2014 (JP) 2014-206463

(51) Int. Cl. C21D 8/12; C22C 30/02; H01F 1/055; C22F 1/00; B22F 3/10; B22F 1/00; C21D 1/18

(52) U.S. Cl. CPC C21D 8/1216; B22F 1/0003; C22C 30/02; C21D 1/18; C21D 8/12; C22F 1/00; B22F 3/10; H01F 1/0557

(57) ABSTRACT

Provided is a method for manufacturing a rare-earth magnet capable of manufacturing a rare-earth magnet having excellent magnetic characteristics from magnetic powder that is prepared by liquid rapid-quenching and including both of nano-crystalline substance and amorphous substance as well. A method for manufacturing a rare-earth magnet includes: a first step of rapidly quenching of molten metal that is represented by a composition formula of (R1)ₓ(Rh)_{y}T_{z}BₛMₜ (R1 denotes one type or more of light rare-earth element containing Y, Rh denotes a heavy rare-earth element containing at least one type of Dy and Tb, T denotes transition metal containing at least one type of Fe, Ni and Co, B denotes boron, M denotes at least one type of Ga, Al and Cu, and 27≦x≦44, 0≦y≦10, z=100-x-y-s-t, 0.75≦s≦3.4, 0≦t≦3 all in terms of percent by mass) to prepare magnetic powder MF including mixture of nano-crystalline magnetic powder having an average crystalline grain size of 500 nm or less and amorphous magnetic powder; and a second step of sintering the magnetic powder MF including the mixture of nano-crystalline magnetic powder and the amorphous magnetic powder to prepare a sintered body S, and performing hot deformation processing of the sintered body S to manufacture the rare-earth magnet C.

### CLAIM OF PRIORITY

The present application claims priority from Japanese patent application JP 2014-206463 filed on Oct. 7, 2014, the content of which is hereby incorporated by reference into this application.

### BACKGROUND

1. Technical Field

The present invention relates to a method for manufacturing a rare-earth magnet.

2. Background Art

Rare-earth magnets containing rare-earth elements are called permanent magnets as well, and are used for motors making up a hard disk and a MRI as well as for driving motors for hybrid vehicles, electric vehicles and the like.

Indexes for magnet performance of such rare-earth magnets include remanence (residual flux density) and a coercive force. Meanwhile, as the amount of heat generated at a motor increases because of the trend to more compact motors and higher current density, rare-earth magnets included in the motors also are required to have improved heat resistance, and one of important research challenges in the relating technical field is how to keep a coercive force of a magnet operating at high temperatures. In the case of a Nd—Fe—B magnet that is one of the rare-earth magnets often used for vehicle driving motors, an attempt has been made to increase the coercive force of such a magnet by making crystal grains finer, by using an alloy having the composition containing more Nd and by adding heavy rare-earth elements such as Dy and Tb having high coercive-force performance, for example.

Rare-earth magnets include typical sintered magnets including crystalline grains of about 3 to 5 μm in scale making up the structure and nano-crystalline magnets including finer crystalline grains of about 50 nm to 500 nm in nano-scale.

The following briefly describes one example of the method for manufacturing a rare-earth magnet that is such a nano-crystalline magnet. In a typical method, for instance, Nd—Fe—B molten metal is solidified rapidly (rapid solidification) to be fine powder, while pressing-forming the fine powder to be a sintered body. Hot deformation processing is then performed to this sintered body to give magnetic anisotropy thereto to prepare a rare-earth magnet (orientational magnet).

When magnetic powder is prepared by a liquid rapid-quenching method, it is difficult to produce magnetic powder including nano-crystalline substance only in a desired grain size, and magnetic powder actually produced typically includes nano-crystalline substance and amorphous substance. For instance, when magnetic powder is prepared by liquid rapid quenching of molten metal using a single roll made of copper, it is known from the past experience by the present inventor that amorphous magnetic powder accounting for about 30 to 40 volume % is included. Patent Document 1 discloses a method of preparing a sintered body using magnetic powder including nano-crystalline substance and amorphous substance, to which hot deformation processing (in this case, heavily hot processing) is performed to manufacture a rare-earth magnet.

Amorphous magnetic powder tends to be coarse crystalline grains during the preparation of a sintered body by hot forming or during the preparation of a rare-earth magnet by hot deformation processing as post process. Then it is known that a rare-earth magnet containing such coarse crystalline grains deteriorates in magnetic performance greatly compared with a rare-earth magnet not containing coarse crystalline grains. Then a conventional manufacturing method of a rare-earth magnet, including producing magnetic powder by liquid rapid-quenching, producing a sintered body from this magnetic powder, and performing hot deformation processing, removes amorphous magnetic powder, while giving consideration into magnetic characteristics. If rare-earth magnets are mass-produced without removing amorphous magnetic powder, then the defect rate will be 30 to 40%.

Herein, the rapid-quenching rate in the liquid rapid-quenching and the composition of magnetic powder prepared have the following relationship. When magnetic powder including Nd—Fe—B nano-crystalline substance is to be produced by rapid solidification, its range of non-defective product (the range not including amorphous substance and including nano-crystalline substance only) is very narrow, and it is actually very difficult to prepare magnetic powder including nano-crystalline substance only. For instance, if the rapid quenching rate is too slow, the crystals will be coarse, and so the object to be fulfilled originally cannot be achieved that is to improve heat resistance because of nano-crystalline substance. On the other hand, if the rapid quenching rate is too high, then crystallization does not progress, and magnetic powder having amorphous structure only will be produced.

As described above, a method using a single roll made of copper is mainly performed in the liquid rapid quenching. When nano-crystalline magnetic powder only is to be manufactured by such a method, it is required to control all of the temperature of molten metal, its discharge rate and the rotating speed of the single roll precisely. Further, the rapidly-quenched thin body originally prepared has to be a thickness suppressed to about ±2 μm, and such a range corresponds to the range of thickness that is affected by a change in the temperature of molten metal of 10 to 20° C., for example. In this way, the control is difficult because these plurality of factors have to be controlled to yield such a thickness range.

Then in order to manufacture a rare-earth magnet having excellent magnetic characteristics and with high material yield, the relating technical field needs the technique enabling the manufacturing of a rare-earth magnet having excellent magnetic characteristics from magnetic powder that is prepared by liquid rapid-quenching and including both of nano-crystalline substance and amorphous substance.

### RELATED ART DOCUMENTS

### Patent Document

Patent Document 1: JP2012-244111A

### SUMMARY

In view of the aforementioned problems, the present invention aims to provide a method for manufacturing a rare-earth magnet enabling the manufacturing of a rare-earth magnet having good magnetic characteristics from magnetic powder that is prepared by liquid rapid-quenching and including both of nano-crystalline substance and amorphous substance.

To fulfill the object, a method for manufacturing a rare-earth magnet of the present invention includes: a first step of rapidly quenching of molten metal that is represented by a composition formula of (R1)ₓ(Rh)_{y}T_{z}BₛMₜ (R1 denotes one type or more of light rare-earth element containing Y, Rh denotes a heavy rare-earth element containing at least one type of Dy and Tb, T denotes transition metal containing at least one type of Fe, Ni and Co, B denotes boron, M denotes at least one type of Ga, Al and Cu, and 27≦x≦44, 0≦y≦10, z=100-x-y-s-t, 0.75≦s≦3.4, 0≦t≦3 all in terms of percent by mass) to prepare magnetic powder including mixture of nano-crystalline magnetic powder having an average crystalline grain size of 500 nm or less and amorphous magnetic powder; and a second step of sintering the magnetic powder including the mixture of nano-crystalline magnetic powder and amorphous magnetic powder to prepare a sintered body, and performing hot deformation processing of the sintered body to manufacture the rare-earth magnet.

The method of the present invention is to rapidly quench molten metal that is represented by a composition formula of (R1)ₓ(Rh)_{y}T_{z}BₛMₜ (R1 denotes one type or more of light rare-earth element containing Y, Rh denotes a heavy rare-earth element containing at least one type of Dy and Tb, T denotes transition metal containing at least one type of Fe, Ni and Co, B denotes boron, M denotes at least one type of Ga, Al and Cu, and 27≦x≦44, 0≦y≦10, z=100-x-y-s-t, 0.75≦s≦3.4, 0≦t≦3 all in terms of percent by mass) to prepare magnetic powder for rare-earth magnet, and to manufacture a rare-earth magnet using this magnetic powder, and so can manufacture a rare-earth magnet having excellent magnetic characteristics from magnetic powder including both of nano-crystalline substance and amorphous substance as well and without removing the amorphous magnetic powder.

A rare-earth magnet as a target for manufacturing of the method of the present invention includes nano-crystalline magnetic powder having the average crystalline grain size of 500 nm or less. Herein the “average crystalline grain size” refers to an area average crystalline grain size. Specifically, a structure in a fixed range is observed on a SEM image or the like, and ellipse of inertia of each crystal grain is found and its major axis is considered as a crystalline grain size. Then weighting for area of each crystal grain is assigned to the crystalline grain size, and the average is found, which is the area average crystalline grain size.

In the first step, magnetic powder represented by the composition formula as stated above is firstly prepared by liquid rapid-quenching. For instance, a melt-spun ribbon (rapidly quenched ribbon) that is fine crystal grains is prepared by liquid rapid-quenching, which is then coarse-ground to prepare magnetic powder for rare-earth magnet including the mixture of nano-crystalline magnetic powder and amorphous magnetic powder.

Next, in the second step, such magnetic powder including the mixture of nano-crystalline magnetic powder and amorphous magnetic powder is directly loaded in a die, and sintering is performed while applying pressure thereto to be bulk, whereby an isotropic sintered body can be obtained. In this way, the sintered body is manufactured without removing amorphous magnetic powder, and by performing hot forming to the magnetic powder including the mixture with nano-crystalline substance.

In the second step, hot deformation processing is then performed so as to give magnetic anisotropy to the isotropic sintered body. This hot deformation processing may be upset forging processing, extrusion forging processing (forward extrusion, backward extrusion) or the like, among which one type or two types or more in combination may be used to introduce processing strain inside the sintered body for heavily deformation processing at the rate of processing that is about 60 to 80%, whereby a rare-earth magnet having high degree of orientation and having excellent magnetization performance can be manufactured.

The present inventors demonstrated that amorphous magnetic powder does not become coarse even after a plurality of steps of hot processing, such as the preparation of a sintered body by hot forming and the preparation of a rare-earth magnet by hot deformation processing, and the structure finally obtained includes a crystalline structure having the average crystalline grain size of 500 nm or less. This is the reason why, even when a rare-earth magnet is manufactured from the state containing amorphous magnetic powder, the rare-earth magnet obtained can have excellent magnetic characteristics.

As can be understood from the descriptions, the method of the present invention is to rapidly quench molten metal that is represented by a composition formula of (R1)ₓ(Rh)_{y}T_{z}BₛMₜ (R1 denotes one type or more of light rare-earth element containing Y, Rh denotes a heavy rare-earth element containing at least one type of Dy and Tb, T denotes transition metal containing at least one type of Fe, Ni and Co, B denotes boron, M denotes at least one type of Ga, Al and Cu, and 27≦x≦44, 0≦y≦10, z=100-x-y-s-t, 0.75≦s≦3.4, 0≦t≦3 all in terms of percent by mass) to prepare magnetic powder for rare-earth magnet, and to manufacture a rare-earth magnet using this magnetic powder, and so can manufacture a rare-earth magnet having excellent magnetic characteristics effectively and without degrading the material yield, and without removing amorphous magnetic powder.

### BRIEF DESCRIPTION OF THE DRAWINGS

FIG. 1 schematically describes a method for manufacturing magnetic powder that is used in a first step of a method for manufacturing a rare-earth magnet of the present invention.

FIG. 2 schematically describes a second step of the method for manufacturing a rare-earth magnet of the present invention.

FIG. 3 schematically describes the second step of the method for manufacturing a rare-earth magnet of the present invention, following FIG. 2.

FIG. 4A describes a micro-structure of a sintered body in FIG. 2, and FIG. 4B describes a micro-structure of a rare-earth magnet in FIG. 3.

FIG. 5 shows the result of the experiment to measure the coercive forces and the amount of heat generation at the crystallization temperature of rare-earth magnets that were produced by liquid rapid-quenching in association with the thicknesses of the magnetic powder.

FIG. 6 shows the result of the experiment for the measurements of Example and Comparative example, relating to magnetization of rare-earth magnets in accordance with the thicknesses of magnetic powder that was prepared by liquid rapid-quenching.

FIG. 7 shows SEM image photos of the structures of the magnetic powder and structures of the rare-earth magnets of Example and Comparative example.

### DETAILED DESCRIPTION OF THE EMBODIMENT(S)

The following describes an embodiment of a method for manufacturing a rare-earth magnet of the present invention, with reference to the drawings.

(Embodiment of Method for Manufacturing a Rare-Earth Magnet)

The manufacturing method of the present invention begins with a first step, where molten metal is rapidly quenched by liquid rapid quenching to prepare magnetic powder containing the mixture of nano-crystalline magnetic powder and amorphous magnetic powder.

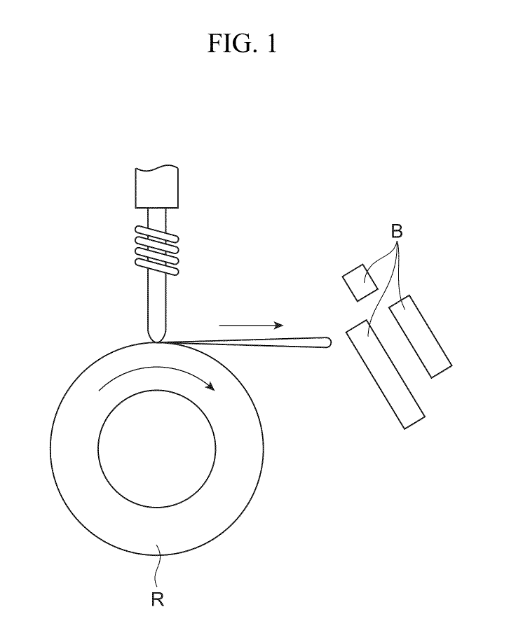

As illustrated in FIG. 1, alloy ingot is molten at a high frequency, and a molten composition giving a rare-earth magnet is injected to a copper roll R to manufacture a melt-spun ribbon B (rapidly quenched ribbon) by a melt-spun method using a single roll in an oven (not illustrated) under an Ar gas atmosphere at reduced pressure of 50 kPa or lower, for example. The melt-spun ribbon obtained is then coarse-ground to prepare magnetic powder.

The thus prepared magnetic powder can be represented by a composition formula of (R1)ₓ(Rh)_{y}T_{z}BₛMₜ (R1 denotes one type or more of light rare-earth element containing Y, Rh denotes a heavy rare-earth element containing at least one type of Dy and Tb, T denotes transition metal containing at least one type of Fe, Ni and Co, B denotes boron, M denotes at least one type of Ga, Al and Cu, and 27≦x≦44, 0≦y≦10, z=100-x-y-s-t, 0.75≦s≦3.4, 0≦t≦3 all in terms of percent by mass). The magnetic powder has a structure made up of main phase and grain boundary phase, and includes the mixture of nano-crystalline magnetic powder having the average crystalline grain size of 500 nm or less and amorphous magnetic powder.

The manufacturing method of the present invention does not remove amorphous magnetic powder, which is used as the magnetic powder for rare-earth magnet together with nano-crystalline magnetic powder. In this way, the material yield does not deteriorate, and the step of selecting amorphous magnetic powder for removal can be omitted, and so a rare-earth magnet can be manufactured effectively.

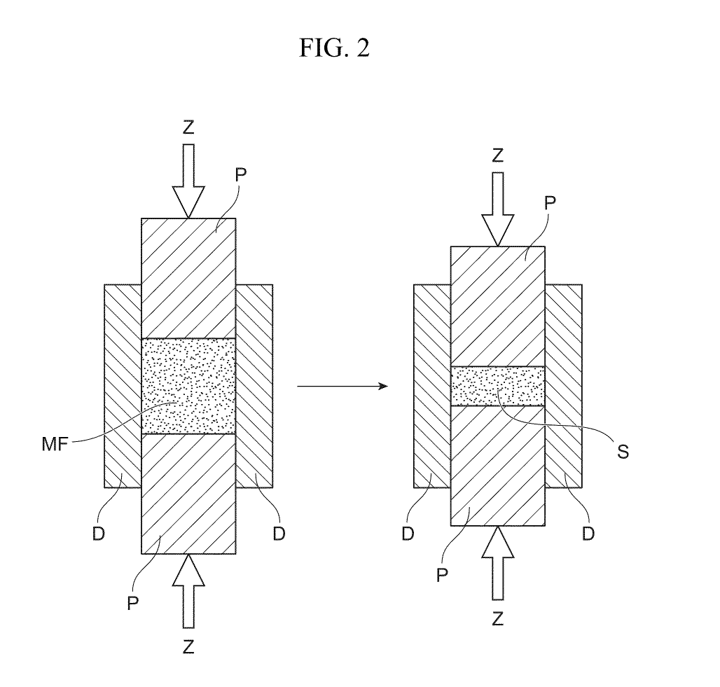

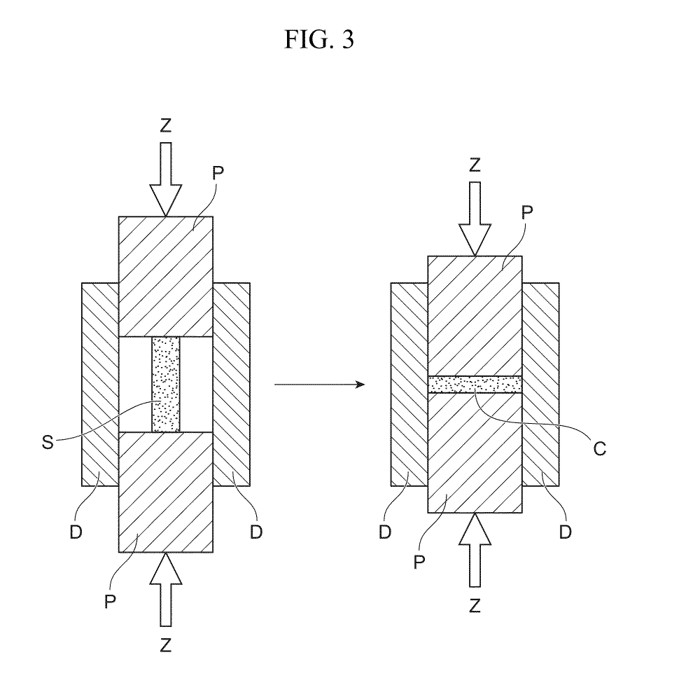

Next, as illustrated in FIGS. 2 and 3, in a second step, the magnetic powder MF including the mixture of nano-crystalline magnetic powder and amorphous magnetic powder is sintered to prepare a sintered body S, and then hot deformation processing is performed to the sintered body S to manufacture a rare-earth magnet C.

FIG. 2 describes a method for manufacturing the sintered body S in the second step. As illustrated in this drawing, the magnetic powder MF including the mixture of nano-crystalline magnetic powder having the average crystalline grain size of 500 nm or less and amorphous magnetic powder is placed in a cavity defined by a carbide die D and a carbide punch P sliding along the hollow of the carbide die.

Then, ormic-heating at about 800° C. is performed while applying pressure with the carbide punch P (Z direction) and letting current flow through in the pressuring direction, whereby the sintered body S is prepared. This sintered body S, for example, has a Nd—Fe—B main phase having nano-crystalline structure and Nd—X alloy (X: metal element) grain boundary phase around the main phase. That is, amorphous magnetic powder also is crystallized by hot forming to form a nano-crystalline structure (at the stage of sintering, however, an amorphous structure may remain to some extent). Herein, the Nd—X alloy making up the grain boundary phase of the sintered boy S is an alloy containing Nd and at least one type of Co, Fe, Ga and the like, which may be any one type of Nd—Co, Nd—Fe, Nd—Ga, Nd—Co—Fe, Nd—Co—Fe—Ga, or the mixture of two types or more of them, and is in a Nd-rich state.

Once the sintered body S is prepared as illustrated in FIG. 2, then as illustrated in FIG. 3, in order to give magnetic anisotropy to the sintered body S, the sintered body S is placed in the cavity defined by the carbide die D and the carbide punch P, and hot deformation processing is performed while pressing with the carbide punch P (Z direction), so as to manufacture a rare-earth magnet C (orientational magnet) in which the sintered body S is crushed (second step). The rate of strain is favorably adjusted at 0.1/sec. or more during hot deformation processing. When the degree of processing (rate of compression) by the hot deformation processing is large, e.g., when the rate of compression is about 10% or more, such hot deformation processing can be called heavily deformation processing. The hot deformation processing is favorably performed in the range of the degree of processing that is about 60 to 80%. Even when an amorphous structure remains at the stage of the sintered body S, such an amorphous structure undergone this hot deformation processing can be a nano-crystalline structure.

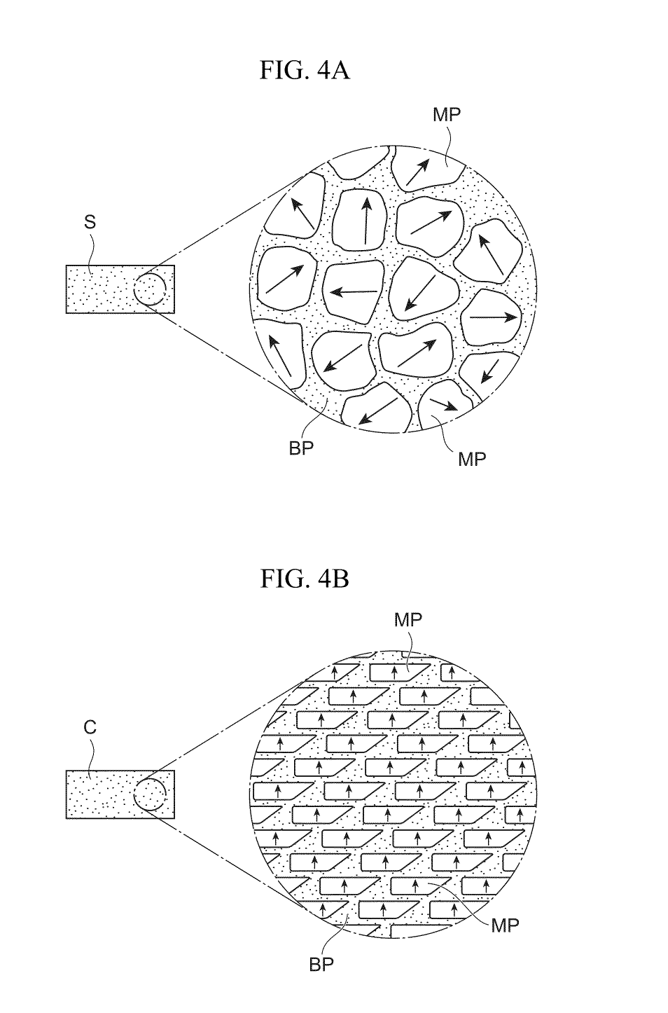

As illustrated in FIG. 4A, the sintered body S prepared in the second step shows an isotropic crystalline structure where the space between the nano-crystalline grains MP (main phase) is filled with the grain boundary phase BP.

On the other hand, as illustrated in FIG. 4B, the rare-earth magnet C prepared in the second step shows a magnetic anisotropic crystalline structure.

As described above, the manufacturing method of the present invention does not remove amorphous magnetic powder to prepare the sintered body S, which is used in the mixed state with nano-crystalline magnetic powder. This means that, although the manufacturing efficiency is good as stated above, the rare-earth magnet C obtained finally may have degraded magnetic characteristics.

However, the magnetic powder used is represented by a composition formula of (R1)ₓ(Rh)_{y}T_{z}BₛMₜ (R1 denotes one type or more of light rare-earth element containing Y, Rh denotes a heavy rare-earth element containing at least one type of Dy and Tb, T denotes transition metal containing at least one type of Fe, Ni and Co, B denotes boron, M denotes at least one type of Ga, Al and Cu, and 27≦x≦44, 0≦y≦10, z=100-x-y-s-t, 0.75≦s≦3.4, 0≦t≦3 all in terms of percent by mass). This can prevent coarsening of amorphous magnetic powder even after a plurality of steps of hot processing, such as the preparation of the sintered body S by hot forming and the preparation of the rare-earth magnet C by hot deformation processing, and the structure finally obtained includes a crystalline structure having the average crystalline grain size of 500 nm or less. In this way, even when the rare-earth magnet C is manufactured from the state containing amorphous magnetic powder, the rare-earth magnet obtained can have excellent magnetic characteristics. That is, the method of the present invention enables manufacturing of a rare-earth magnet C having excellent magnetic characteristics effectively and so as not to degrade the material yield.

(Experiment to Evaluate Magnetic Characteristics of a Rare-Earth Magnet Manufactured by the Manufacturing Method of the Present Invention and to Observe the Structure, and Results Thereof)

The present inventors conducted the experiment to evaluate magnetic characteristics of a rare-earth magnet manufactured by the manufacturing method of the present invention and observe the structure.

### EXAMPLE

Liquid rapidly-quenched ribbons having the composition of Nd_{28.7}Pr_{0.415}Fe_{69.29}B_{0.975}Ga_{0.4}Al_{0.11}Cu_{0.106} and thicknesses from 10 to 28 μm were prepared using a single copper role, to prepare a plurality of types of magnetic powder. Herein the “thickness of magnetic powder” refers to the dimension perpendicular to the rotating direction of the single roll, and thinner magnetic powder underwent more rapid-quenching. The following Table 1 shows the manufacturing conditions of a plurality of types of magnetic powder and the thicknesses of the magnetic powder.

TABLE 1

| | | | Values as substitute for molten | |
|---|---|---|---|---|
| | | | metal discharge amount | |
| | | | Hole diameter of | |
| | Thickness of | Rotating speed | crucible for | Temperature |
| | magnetic | of single roll | dropping of | of molten |
| No. | powder (μm) | (rpm) | molten metal (mm) | metal (T) |
| 1 | 53.55 | 600 | 0.6 | 1400 |
| 2 | 38.15 | 900 | 0.6 | 1400 |
| 5 | 34.55 | 1000 | 0.65 | 1400 |
| 3 | 31.9 | 1000 | 0.5 | 1400 |
| 4 | 28.35 | 1200 | 0.65 | 1400 |
| 8 | 26 | 1200 | 0.6 | 1400 |
| 6 | 22.3 | 1200 | 0.5 | 1400 |
| 7 | 19.4 | 1400 | 0.5 | 1400 |

The sintered body was prepared under the conditions such that it was placed in a cemented carbide mold heated at 700° C., and press-burning was performed with the load of 400 MPa, which was held for three minutes. Then, the resultant was taken out from the mold. The sintered body was prepared in this way.

Conditions for hot deformation processing of the sintered body were heating temperature at 780° C., the rate of strain of 0.1/sec, and the amount of strain of 40%, 50% and 60%. In this way, rare-earth magnets were manufactured.

### <Experimental Results>

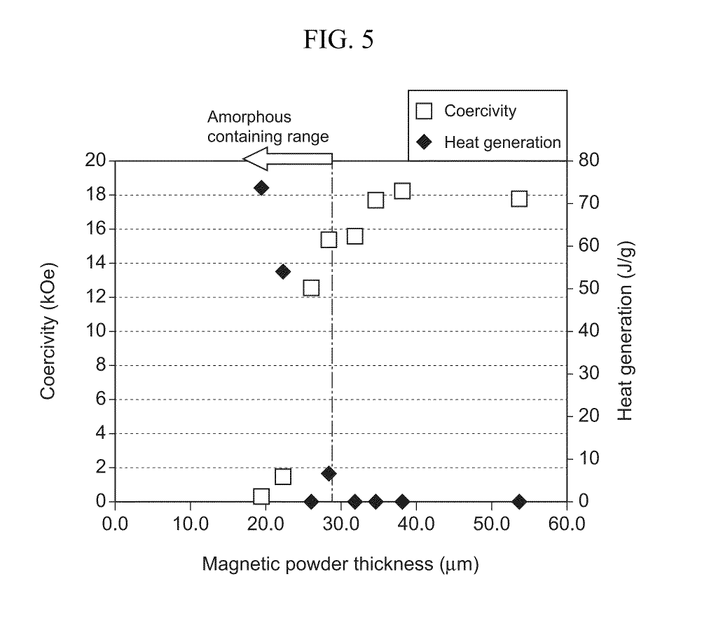

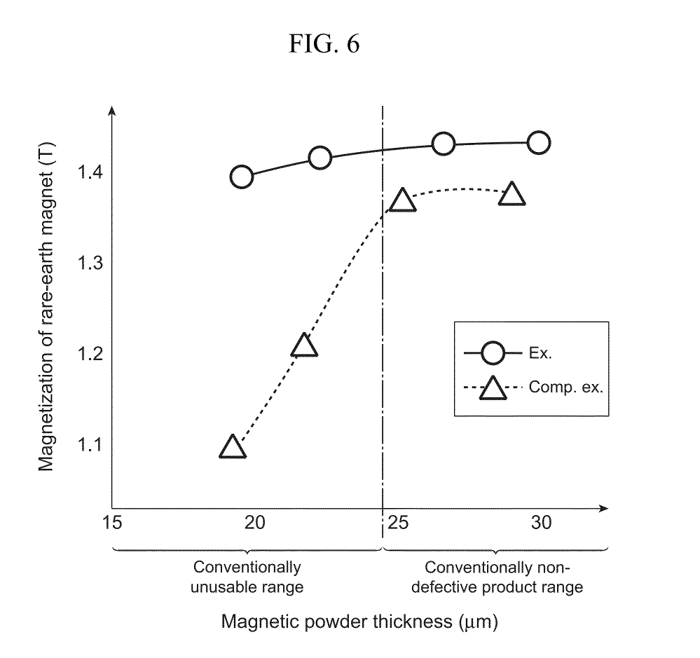

FIG. 5 and the following Table 2 show the result to examine the range containing amorphous substance in association with the thicknesses of magnetic powder, and the experimental result relating to the coercive forces and the amount of heat generation at the crystallization temperature in association with the thicknesses of the magnetic powder. FIG. 6 and the following Table 3 show the measurements relating to magnetization of rare-earth magnets in association with the thicknesses of magnetic powder that was prepared by liquid rapid-quenching.

TABLE 2

| | Thickness of | | Amount of heat generation |
|---|---|---|---|
| | magnetic | Coercive force | at crystallization |
| No. | powder (μm) | Hcj (kOe) | temperature (J/g) |
| 1 | 53.55 | 17.8 | — |
| 2 | 38.15 | 18.2 | — |
| 5 | 34.55 | 17.7 | — |
| 3 | 31.9 | 15.6 | 0 |
| 4 | 28.35 | 15.4 | 6.7 |
| 8 | 26 | 12.5 | 0 |
| 6 | 22.3 | 1.5 | 54 |
| 7 | 19.4 | 0.3 | 73.5 |

TABLE 3

| | |
|---|---|
| Thickness of | Residual flux density |
| magnetic | (magnetization) (T) |

| No. | powder (μm) | Comp. Ex. | Ex. |
|---|---|---|---|
| 1 | 53.55 | Unvalued | Unvalued |
| 2 | 38.15 | Unvalued | Unvalued |
| 5 | 34.55 | Unvalued | Unvalued |
| 3 | 31.9 | Unvalued | Unvalued |
| 4 | 28.35 | 1.37 | 1.44 |
| 8 | 26 | 1.36 | 1.44 |
| 6 | 22.3 | 1.2 | 1.42 |
| 7 | 19.4 | 1.1 | 1.39 |

It can be found from FIG. 5 and Table 2 that the range of the thickness of magnetic powder that is less than 30 μm (the dotted line in the drawing around 28 μm) was the region where amorphous magnetic powder exists, and a rare-earth magnet manufactured from the magnetic powder in this region had a very small coercive force of 2 kOe or less. On the other hand, the amount of heat generation at the crystallization temperature was very high that was 54 (J/g) or more.

On the other hand, a rare-earth magnet manufactured from the magnetic powder in the region not containing amorphous substance, i.e., containing nano-crystalline magnetic powder only had a very high coercive force of about 15 kOe to 18 kOe, and the amount of heat generation at the crystallization temperature also was zero or 6.7 (J/g).

In FIG. 6, the solid line shows the result of the manufacturing method of the present invention (Example, a method for manufacturing a rare-earth magnet, using magnetic powder having the composition as stated above, and including the mixture of nano-crystalline substance and amorphous substance), and the dotted line shows the result of the conventional manufacturing method (Comparative example, a method for manufacturing a rare-earth magnet, not using magnetic powder having the composition as stated above, and including the mixture of nano-crystalline substance and amorphous substance).

It can be found from FIG. 6 and Table 3 that, in the case of Comparative example, the range of the thickness of magnetic powder less than 25 μm made amorphous magnetic powder coarse, thus degrading magnetization characteristics. In this way, in the case of Comparative example, the thickness range of 25 pm or more, i.e., magnetic powder in the conventional range of non-defective product, only has to be used so as to acquire a rare-earth magnet having good magnetic characteristics.

On the other hand, Example shows a high value that was about 1.4 T or higher about magnetization of the rare-earth magnets irrespective of the thickness range of magnetic powder. In this way, a rare-earth magnet having excellent magnetic characteristics was successfully manufactured using magnetic powder that was prepared by liquid rapid-quenching as a whole without selecting the magnetic powder based on the thickness range.

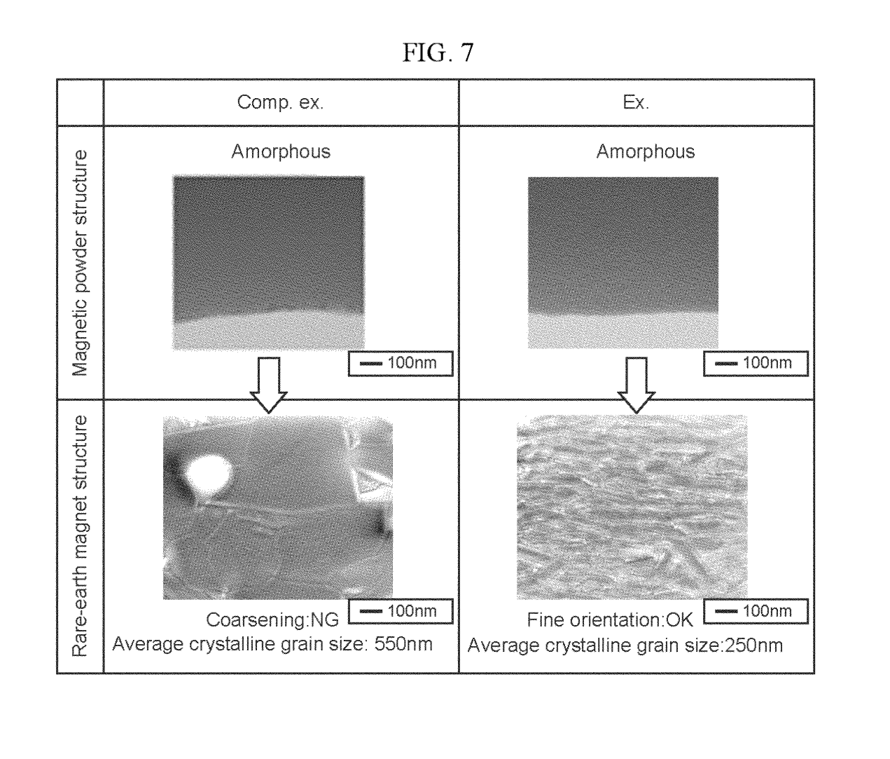

FIG. 7 show SEM image photos of the structures of the magnetic powder and structures of the rare-earth magnets of Example and Comparative example.

Comparative example showed coarsening of amorphous magnetic powder in the structure of the rare-earth magnet prepared by hot deformation processing, and the crystalline structure had the average crystalline grain size of 550 nm. On the other hand, Example did not show coarsening of amorphous magnetic powder, and the crystalline structure had the average crystalline grain size of 250 nm.

In this way, it was demonstrated that the magnetic powder that was represented by a composition formula of (R1)ₓ(Rh)_{y}T_{z}BₛMₜ (R1 denotes one type or more of light rare-earth element containing Y, Rh denotes a heavy rare-earth element containing at least one type of Dy and Tb, T denotes transition metal containing at least one type of Fe, Ni and Co, B denotes boron, M denotes at least one type of Ga, Al and Cu, and 27≦x≦44, 0≦y≦10, z=100-x-y-s-t, 0.75≦s≦3.4, 0≦t≦3 all in terms of percent by mass), which may include the mixture of amorphous magnetic powder as well as nano-crystalline magnetic powder, enabled a rare-earth magnet having excellent magnetic characteristics.

Although the embodiments of the present invention have been described in details with reference to the drawings, the specific configuration is not limited to these embodiments, and the design may be modified without departing from the subject matter of the present invention, which falls within the present invention.

### DESCRIPTION OF SYMBOLS

R Copper roll
B Melt-spun ribbon (rapidly quenched ribbon)
D Carbide die
P Carbide punch
S Sintered body
C Rare-earth magnet
MF Magnetic powder (nano-crystalline magnetic powder, amorphous magnetic powder, magnetic powder including the mixture of nano-crystalline substance and amorphous substance)
MP Main phase (nano-crystalline grains, crystalline grains)
BP Grain boundary phase

What is claimed is:

1. A method for manufacturing a rare-earth magnet, comprising:
a first step of rapidly quenching of molten metal that is represented by a composition formula of (R1)ₓ(Rh)_{y}T_{z}BₛMₜ (R1 denotes one type or more of light rare-earth element containing Y, Rh denotes a heavy rare-earth element containing at least one type of Dy and Tb, T denotes transition metal containing at least one type of Fe, Ni and Co, B denotes boron, M denotes at least one type of Ga, Al and Cu, and 27≦x≦44, 0≦y≦10, z=100-x-y-s-t, 0.75≦s≦3.4, 0≦t≦3 all in terms of percent by mass) to prepare magnetic powder including mixture of nano-crystalline magnetic powder having an average crystalline grain size of 500 nm or less and amorphous magnetic powder; and
a second step of sintering the magnetic powder including the mixture of nano-crystalline magnetic powder and amorphous magnetic powder to prepare a sintered body, and performing hot deformation processing of the sintered body to manufacture the rare-earth magnet.
